(19) United States
(12) Patent Application Publication
(10) Pub. No.: US 2025/0132704 A1
(43) Pub. Date: Apr. 24, 2025

(54) DRIVE CIRCUIT, CHIP AND ELECTRONIC DEVICE

(71) Applicant: CHIPSEMI SEMICONDUCTOR (NINGBO) CO., LTD., Ningbo (CN)

(72) Inventors: Yaoguo Zhang, Ningbo (CN); Haifeng Shen, Ningbo (CN); Yulin Zhang, Ningbo (CN); Bo Xia, Ningbo (CN); Bo Nie, Ningbo (CN); Congqing Yu, Ningbo (CN); Guofan Cheng, Ningbo (CN); Jui-Ming Ni, Ningbo (CN)

(21) Appl. No.: 18/988,539

(22) Filed: Dec. 19, 2024

Related U.S. Application Data
(63) Continuation of application No. PCT/CN2023/089560, filed on Apr. 20, 2023.

(30) Foreign Application Priority Data
Nov. 30, 2022 (CN) 202211514835.X

(51) Int. Cl. H02P 7/03

(52) U.S. Cl. CPC H02P 7/04; H02P 7/05

(57) ABSTRACT

This application discloses a drive circuit, chip, and electronic device. The drive circuit includes an operational amplifier constant-current source circuit with an operational amplifier, a first switch coupled to the second node, a first resistor, and a second resistor; an H-bridge circuit with diagonally arranged second and fifth switches and third and fourth switches, configured to provide drive current to a motor; a switching circuit coupled to the second node, and control terminals of the second and third switches, configured to connect the second node to the control terminal of the second switch based on a valid first control signal, and/or to the control terminal of the third switch based on a valid second control signal; and a matching resistor coupled to the H-bridge circuit and ground voltage. This configuration provides stable and precise motor drive current even in high-frequency environments.

### CROSS REFERENCE TO RELATED APPLICATIONS

This application is a continuation of International Application No. PCT/CN2023/089560, filed on Apr. 20, 2023, which claims the benefit of the Chinese patent application with application number “202211514835.X” filed on Nov. 30, 2022, the disclosure of which is herein incorporated by reference in its entirety for all purposes.

### TECHNICAL FIELD

The present application relates to the field of electrical circuits and equipment, and more particularly, to a drive circuit, a chip, and an electronic device.

### BACKGROUND

To drive a motor, a corresponding drive circuit is required. Currently, the drive circuit used for driving motors is typically as shown in FIG. 1: switches 1, 2, 3 and 4 form an H-bridge circuit; operational amplifier 6, resistor 7 and switch 8 constitute a constant current source circuit. The H-bridge circuit serves as a load in the operational amplifier's constant current source circuit.

This configuration allows the specific magnitude of current generated by the constant current source circuit to drive motor 5 in a forward or reverse rotation, achieving stable and precise control of the motor's operating state.

In this setup, the H-bridge circuit controls the forward and reverse rotation of motor 5. By inputting specific voltage signals s1, s2, s3 and s4 to the control terminals of switches 1, 2, 3 and 4, the H-bridge circuit ensures that only switches 1 and 4 are conducting, or only switches 2 and 3 are conducting. This results in current flowing from the right end to the left end of motor 5, or from the left end to the right end, thereby controlling the motor's rotational direction.

The operational amplifier's constant current source circuit controls the operating current of motor 5. Resistor 7 forms the feedback path of the operational amplifier. The circuit stabilizes when the voltages at the non-inverting and inverting input terminals of operational amplifier 6 become equal. In other words, the voltage at the inverting input terminal of operational amplifier 6 remains stable after reaching the control voltage V_{ref} applied to its non-inverting input terminal. Stability is achieved when Iₒᵤₜ=V_{ref}/R₇ (where R₇ is the resistance value of resistor 7). Therefore, by controlling the magnitude of V_{ref}, the magnitude of the operating current Iₒᵤₜ flowing through resistor 7 and motor 5 can be regulated.

However, the aforementioned drive circuit cannot provide stable and precise control in high-frequency environments and may even exhibit significant ringing phenomena during transient responses.

### SUMMARY

To solve the above technical problems, the embodiments of the invention disclosed in this application provide embodiments of the present application provide a drive circuit comprising: an operational amplifier constant current source circuit, an H-bridge circuit, a switching circuit, and a matching resistor.

The operational amplifier constant current source circuit includes an operational amplifier, a first switching transistor, a first resistor, and a second resistor. The first resistor is coupled between a power supply voltage and the input terminal of the first switching transistor. The second resistor is coupled between a first node and ground. The inverting input terminal of the operational amplifier and the output terminal of the first switching transistor are coupled to the first node. The output terminal of the operational amplifier is coupled to the control terminal of the first switching transistor at a second node. The non-inverting input terminal of the operational amplifier is configured to receive an input voltage signal.

The H-bridge circuit is coupled between the power supply voltage and the matching resistor and includes a second switching transistor, a third switching transistor, a fourth switching transistor, and a fifth switching transistor. The H-bridge circuit is configured to provide a driving current to a motor under the following conditions: When both the second and fifth switching transistors are turned on and both the third and fourth switching transistors are turned off, or When both the second and fifth switching transistors are turned off and both the third and fourth switching transistors are turned on. In this configuration, the second and fifth switching transistors are positioned diagonally relative to each other, as are the third and fourth switching transistors.

The switching circuit is coupled to the second node, the control terminal of the second switching transistor, and the control terminal of the third switching transistor. The switching circuit is configured to operate as follows:
In response to a first control signal being valid, the switching circuit connects the second node to the control terminal of the second switching transistor. The first control signal is an input from a microcontroller or a control circuit or any other control inpu, similar to control signals S1-S4 shown in FIG. 1. It can have two values/states: valid (1) or invalid (0). When the first control signal transitions to or is in the valid state (1), the specified action is triggered.
In response to a second control signal being valid, the switching circuit connects the second node to the control terminal of the third switching transistor. The second control signal is an input from a microcontroller or a control circuit or any other control inpu, similar to control signals S1-S4 shown in FIG. 1. The second control signal can have two values/states: valid (1) or invalid (0). When the second control signal transitions to or is in the valid state (1), the specified action is triggered.

This configuration ensures that the voltage at the second node controls the conduction of the second and/or third switching transistors, depending on the value/state of the control signal.

Additionally, one end of the matching resistor is coupled to the H-bridge circuit, and the other end is coupled to ground.

In some embodiments, the switching circuit includes a first switch and a second switch: The first switch is connected between the second node and the control terminal of the second switching transistor. It is designed to remain in a conducting state when a first control signal generated by an external microcontroller (or logic circuits, PWM control or other user control) is valid (1); The second switch is connected between the second node and the control terminal of the third switching transistor. It is designed to remain in a conducting state when the second control signal is valid (1).

In some embodiments, the switching circuit is further configured as follows: when connecting the second node to the control terminal of the second switching transistor in response to the first control signal from a microcontroller (or other forms external control circuit) being valid, it also connects the control terminal of the fifth switching transistor to its turn-on voltage based on the same valid first control signal. Similarly, when connecting the second node to the control terminal of the third switching transistor in response to the second control signal being valid, it also connects the control terminal of the fourth switching transistor to its turn-on voltage based on the same valid second control signal.

In some embodiments, the switching circuit includes a third switch and a fourth switch. The third switch is coupled between the turn-on voltage of the fifth switching transistor and its control terminal. It is configured to remain in a conducting state when the first control signal is valid (1). The fourth switch is coupled between the turn-on voltage of the fourth switching transistor and its control terminal. It is configured to remain in a conducting state when the first control signal is valid.

In some embodiments, the switching circuit is further configured as follows:
When the second node is connected to the control terminal of the second switching transistor in response to the first control signal being valid (1), the control terminal of the third switching transistor is also connected to or disconnected from its turn-off voltage based on the state of the third control signal. Specifically, if the third control signal is valid (1), the connection between the control terminal of the third switching transistor and its turn-off voltage is established; if the third control signal is invalid (0), the third switching transistor is disconnected from its turn-off voltage.
Similarly, when the second node is connected to the control terminal of the third switching transistor in response to the second control signal being valid (1), the control terminal of the second switching transistor is connected to or disconnected from its turn-off voltage based on the state of the fourth control signal. Specifically, if the fourth control signal is valid (1), the connection is established; if the fourth control signal is invalid (0), the connection is removed.

In some embodiments, the switching circuit includes a fifth switch and a sixth switch: the fifth switch is coupled between the control terminal of the third switching transistor and its turn-off voltage and is configured to maintain a conducting state when the third control signal is valid. The sixth switch is coupled between the control terminal of the second switching transistor and its turn-off voltage and is configured to maintain a conducting state when the fourth control signal is valid.

In some embodiments, the switching circuit is further configured as follows:
When the control terminal of the third switching transistor is connected to its turn-off voltage in response to the third control signal being valid (1), the control terminal of the fourth switching transistor is also connected to or disconnected from to its turn-off voltage based on the state of the third control signal. Specifically, if the third control signal is valid (1), the connection between the control terminal of the fourth switching transistor and its turn-off voltage is established; if the third control signal is invalid (0), the fourth switching transistor is disconnected from its turn-off voltage.
When the control terminal of the second switching transistor is connected to its turn-off voltage in response to the fourth control signal being valid (1), the control terminal of the fifth switching transistor is also connected to or disconnected from to its turn-off voltage based on the state of the fourth control signal. Specifically, if the fourth control signal is valid (1), the connection between the control terminal of the fifth switching transistor and its turn-off voltage is established; if the fourth control signal is invalid (0), the fifth switching transistor is disconnected from its turn-off voltage.

In some embodiments, the switching circuit includes a seventh switch and an eighth switch. The seventh switch is coupled between the turn-on voltage of the fourth switching transistor and its control terminal. It is configured to remain in a conducting state when the third control signal is valid (1). The eighth switch is coupled between the control terminal of the fifth switching transistor and its turn-off voltage. The eighth switch is configured to remain in a conducting state when the fourth control signal is valid.

In some embodiments, the turn-off voltage of the second and third switching transistors is ground voltage. The turn-on and turn-off voltages of the fourth switching transistor are ground voltage and power supply voltage, respectively. The turn-on and turn-off voltages of the fifth switching transistor are power supply voltage and ground voltage, respectively.

In some embodiments, the resistance value of the matching resistor satisfies the following condition: k*R2=R3, where R2 and R3 are the resistance values of the second resistor and the matching resistor, respectively, and k is the ratio of the channel width-to-length ratio of the first switching transistor to that of the second switching transistor. The second and third switching transistors have the same channel width-to-length ratio.

Embodiments of the present application also provide a chip comprising the drive circuit described above.

Furthermore, embodiments of the present application provide an electronic device comprising the above-mentioned chip.

### BRIEF DESCRIPTION OF THE DRAWINGS

The accompanying figures (FIGs.) illustrate embodiments and explain principles of the disclosed embodiments. It is to be understood, however, that these figures are presented for purposes of illustration only, and not for defining limits of relevant applications.

FIG. 1 is a schematic structural diagram of a drive circuit in the prior art.

FIG. 2 is a schematic structural diagram of a drive circuit according to an embodiment.

FIG. 3 is a schematic structural diagram of a drive circuit including a first switch and a second switch, according to an embodiment.

FIG. 4 is a first schematic structural diagram of a drive circuit including a third switch and a fourth switch, according to an embodiment.

FIG. 5 is a second schematic structural diagram of a drive circuit including a third switch and a fourth switch, according to an embodiment.

FIG. 6 is a schematic structural diagram of a drive circuit including a fifth switch and a sixth switch, according to an embodiment.

FIG. 7 is a schematic structural diagram of a drive circuit including a seventh switch and an eighth switch, according to an embodiment.

FIG. 8 is a waveform diagram illustrating control signals, voltage signals, and output driving current of a drive circuit, according to an embodiment.

FIG. 9 is another waveform diagram illustrating control signals, voltage signals, and output driving current of a drive circuit, according to an embodiment.

### DETAILED DESCRIPTION OF THE INVENTION

To make the objectives, technical solutions, and advantages of this application clearer, the various embodiments of this application will be described in detail below with reference to the accompanying drawings. However, it is understood by those skilled in the art that numerous technical details have been provided in the embodiments to help readers better understand the application. Nevertheless, the technical solutions claimed in this application can still be realized without these technical details and based on various changes and modifications to the following embodiments. The division of the following embodiments is for convenience of description and should not be construed to limit the scope of the invention disclosed in this application. Each embodiment can be combined and referenced with each other if there is no contradiction.

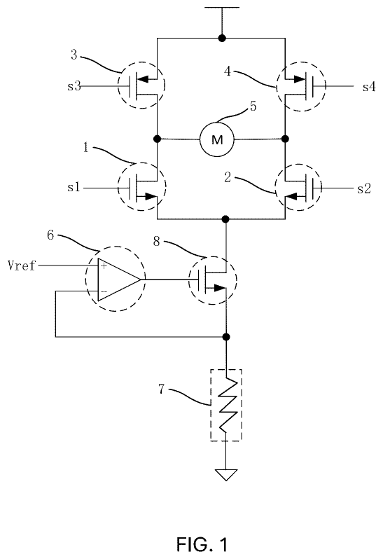

As mentioned above, it is known that the drive circuit currently provided, as shown in FIG. 1, cannot continue to supply a stable and precise driving current to a motor in high-frequency environments.

Analysis has revealed that the cause of this problem lies in the introduction of the H-bridge circuit as a load into the operational amplifier constant current source circuit, forming a loop with it. The motor coupled to the H-bridge circuit contains internal coils, and its impedance can be represented as R+i(ωL), where:
R is the resistance value of the motor in a direct current (DC) environment,
i is the magnitude of the current flowing through the motor,
ω is the frequency of the current change,
L is the equivalent inductance of the motor.

This impedance increases with increasing frequency. In low-frequency environments, since the current change frequency is very low, term i(ωL) has negligible effect. At this time, the motor can be equivalently regarded as a resistor with resistance R, which does not disrupt the stability of the operational amplifier constant current source circuit.

However, in high-frequency environments, i(ωL) becomes significant. When the current rapidly changes from a small value to a large one, due to the characteristics of inductance, the current cannot change instantaneously, that is, the impedance is very high at the moment of change. This causes the output point of the operational amplifier in the drive circuit shown in FIG. 1 to be pulled very low, and the output of the operational amplifier to be pulled very high. It takes a long time to return to a stable state. Especially when switching currents at high frequencies, the coil of the motor will generate a large equivalent resistance, and the voltage provided at the output end of the operational amplifier will be pulled down to ground or up to the supply voltage, resulting in severe distortion. This destroys the original steady state of the operational amplifier constant current source circuit, causing the output current to deviate from the preset value.

To solve the above problem, embodiments of this application provide a drive circuit, a chip, and an electronic device, enabling the drive circuit to remain stable in high-frequency environments without producing significant ringing phenomena during transient responses, and consistently supplying a stable and precise driving current to the motor.

The drive circuit provided by the embodiments includes an H-bridge circuit coupled to a second node through a switching transistor circuit connected to the output end of the operational amplifier in the constant current source circuit. This configuration isolates the current conduction path of the H-bridge circuit from that within the operational amplifier constant current source circuit. Therefore, the stability of the constant current source circuit is determined by the stability of its own components—specifically, the operational amplifier, the first switching transistor, the first resistor, and the second resistor—which can maintain stability in both high-frequency and low-frequency environments.

Consequently, even in high-frequency environments, the constant current source circuit

remains stable, and the voltage provided at the output end of the operational amplifier (the second node) is stable and does not shift. When the switching circuit connects the second node to the control terminal of the second switching transistor in the H-bridge circuit in response to a first control signal being valid, and/or connects the second node to the control terminal of the third switching transistor in response to a second control signal being valid, it can accurately and stably control the conduction current of the second or third switching transistor based on the stable voltage provided at the second node and the matching resistor.

Additionally, since the second and fifth switching transistors in the H-bridge circuit are arranged diagonally, as are the third and fourth switching transistors (i.e., the second and third switching transistors are not arranged diagonally), regardless of the current conduction method adopted by the H-bridge circuit, the driving current supplied to the motor must always pass through either the second or third switching transistor. In other words, by utilizing the stable voltage provided at the second node, the driving current supplied to the motor can be controlled, achieving stable and precise control of the motor's driving current.

In summary, instead of directly introducing the H-bridge circuit as a load into the constant current source circuit, the voltage provided at the output end of the operational amplifier is used as a control source to provide control signals to the control terminals of the switching transistors in the H-bridge circuit. This forms an isolation between the motor's conduction path in the H-bridge circuit and the constant current source circuit. The motor cannot interfere with the constant current source circuit, and even in high-frequency environments, the constant current source circuit remains stable, providing a stable voltage at the output end of the operational amplifier. Through the stable voltage provided at the operational amplifier's output and the matching resistor, the switching transistors in the H-bridge circuit are controlled to conduct with a stable current of a certain magnitude. This means the H-bridge circuit supplies a stable driving current of a certain magnitude to the motor, achieving stable and precise control of the motor's driving current.

To make the objectives, technical solutions, and advantages of the embodiments clearer, the various embodiments will be described in detail below with reference to the accompanying drawings. However, those skilled in the art will understand that numerous technical details are presented in the embodiments to help readers better understand the application. Even without these technical details and various changes and modifications based on the following embodiments, the technical solutions claimed can still be realized.

The division of the following embodiments is for convenience and should not impose any limitations on the specific implementation methods. The various embodiments can be combined or referenced with each other under the premise of no conflict.

### First Embodiment: Drive Circuit

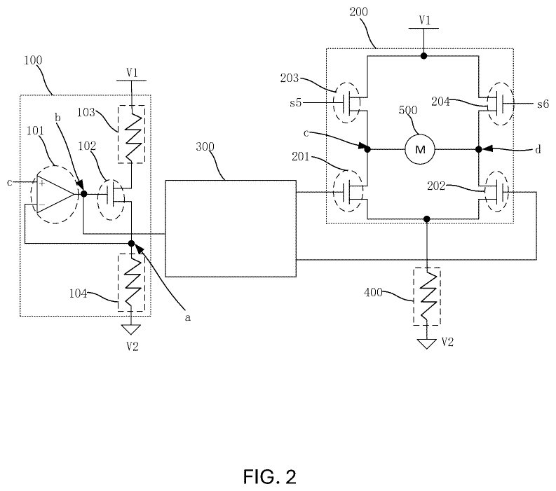

An aspect of the embodiments provides a drive circuit applied in scenarios where a motor is driven to operate. In some embodiments, its structure is shown in FIG. 2 and includes at least the following components:
Operational Amplifier Constant Current Source Circuit 100
H-Bridge Circuit 200
Switching Circuit 300
Matching Resistor 400

The operational amplifier constant current source circuit 100 includes an operational amplifier 101, a first switching transistor 102, a first resistor 103, and a second resistor 104. First resistor 103 is coupled between power supply voltage V1 and input terminal of first switching transistor 102. Second resistor 104 is coupled between a first node a and ground voltage V2. The inverting input terminal of operational amplifier 101 and the output terminal of first switching transistor 102 are coupled at first node a. The output terminal of operational amplifier 101 and the control terminal of first switching transistor 102 are coupled at a second node b. The non-inverting input terminal is configured to receive an input voltage signal Vref.

H-bridge circuit 200 is coupled between power supply voltage V1 and matching resistor 400 and includes second switching transistor 201, third switching transistor 202, fourth switching transistor 203 and fifth switching transistor 204. It is configured to supply a driving current to motor 500 under the following conditions: When both second switching transistor 201 and fifth switching transistor 204 are conducting, both third switching transistor 202 and fourth switching transistor 203 are turned off. Or when both second switching transistor 201 and fifth switching transistor 204 are turned off, both third switching transistor 202 and fourth switching transistor 203 are conducting. In this configuration, the second and fifth switching transistors are arranged diagonally, as are the third and fourth switching transistors.

Switching circuit 300 is coupled to second node b, the control terminal of second switching transistor 201, and the control terminal of third switching transistor 202. It is configured to: in response to a first control signal being valid, connect second node b to the control terminal of second switching transistor 201. And, in response to a second control signal being valid, connect second node b to the control terminal of third switching transistor 202. This controls the conduction of the second and/or third switching transistors connected to second node b based on the voltage provided at that node.

Alternatively, in response to a second control signal being valid, connect second node b to the control terminal of third switching transistor 202. This controls the conduction of the second and/or third switching transistors connected to second node b based on the voltage provided at that node.

Matching resistor 400 has one end coupled to H-bridge circuit 200 and the other end coupled to ground voltage V2.

It is noted that the control terminal is used to control the on-off state of the switching transistor and, when conducting, to control the conduction current. The switching transistor can be a transistor, MOSFET, etc., so the control terminal can be the base of a transistor or the gate of a MOSFET.

Also, it should be noted that motor 500 shown in FIG. 2 is not a component of H-bridge circuit 200. The input terminal and output terminal of motor 500 are respectively coupled to the two output terminals of H-bridge circuit 200.

Compared to the drive circuit shown in FIG. 1, H-bridge circuit 200 is no longer introduced as a load into constant current source circuit 100. The load in constant current source circuit 100 is first resistor 103, which remains stable even in high-frequency environments. Therefore, even in high-frequency environments, current in constant current source circuit 100 does not change, and the circuit remains stable. The voltage provided at the output end of operational amplifier 101 (second node b) is also stable.

Subsequently, when switching circuit 300 connects second node b to the control terminal of second switching transistor 201 in response to a first control signal being valid, and/or connects second node b to the control terminal of third switching transistor 202 in response to a second control signal being valid, it can accurately and stably control the conduction current of the second and/or third switching transistor based on the stable voltage provided at second node b and matching resistor 400.

Moreover, since second and fifth switching transistors 201 and 204 are positioned diagonally relative to each other, and third and fourth switching transistors 202 and 203 are positioned diagonally relative to each other (i.e., the second and third switching transistors are not positioned diagonally relative to each other), regardless of the current conduction method adopted by H-bridge circuit 200, the driving current supplied to motor 500 must always pass through either second switching transistor 201 or third switching transistor 202 and ultimately reach ground voltage V2 through matching resistor 400. In other words, the driving current is controlled by the stable voltage provided at second node b and matching resistor 400.

By utilizing the stable voltage at second node b and matching resistor 400, the drive circuit achieves stable and precise control of the driving current supplied to motor 500.

In some embodiments, as shown in FIG. 2, the output terminals of second switching transistor 201 and third switching transistor 202 are both coupled to ground voltage V2. The input terminals of fourth switching transistor 203 and fifth switching transistor 204 are both coupled to power supply voltage V1. The input terminal of second switching transistor 201 and the output terminal of fourth switching transistor 203 are coupled at node c. The input terminal of third switching transistor 202 and the output terminal of fifth switching transistor 204 are coupled at node d. Motor 500 is coupled between nodes c and d.

Of course, in other embodiments, the arrangement of the switching transistors can vary as long as the diagonal arrangement condition is met.

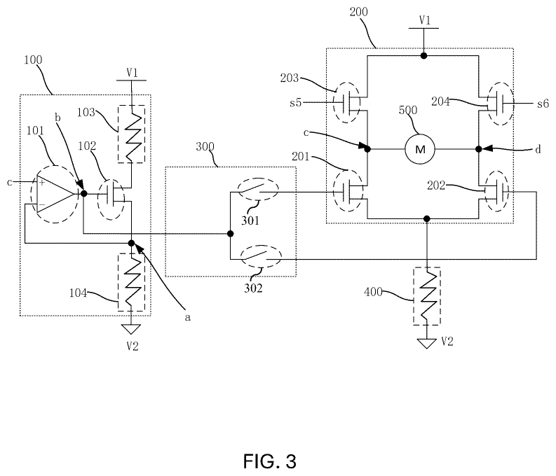

To implement the functions of switching circuit as described above, in some embodiments, as shown in FIG. 3, switching circuit 300 includes:
First Switch 301: Coupled between second node b and control terminal of second switching transistor 201. Configured to remain in a conducting state when the first control signal is valid.
Second Switch 302: Coupled between second node b and control terminal of third switching transistor 202. Configured to remain in a conducting state when second control signal is valid.

Thus, when the first control signal is valid, the first switch 301 conducts, connecting second node b to the control terminal of second switching transistor 201. When the second control signal is valid, the second switch 302 conducts, connecting second node b to the control terminal of third switching transistor 202.

Regarding the control of the fourth and fifth switching transistors, in some embodiments, as shown in FIG. 2, voltage signals s5 and s6 are coupled to their control terminals to control their on-off states by adjusting the voltages.

Alternatively, the control of these transistors can be achieved without coupling voltage signals.

Considering that two diagonally arranged switching transistors in H-bridge circuit 200 simultaneously conduct when supplying driving current to motor 500, switching circuit 300 can further be configured to: When connecting second node b to the control terminal of second switching transistor 201 in response to a first control signal being valid, also connect the control terminal of fifth switching transistor 204 to its turn-on voltage. When connecting second node b to the control terminal of third switching transistor 202 in response to a second control signal being valid, also connect the control terminal of fourth switching transistor 203 to its turn-on voltage.

This ensures that the diagonally arranged pairs of switching transistors conduct simultaneously.

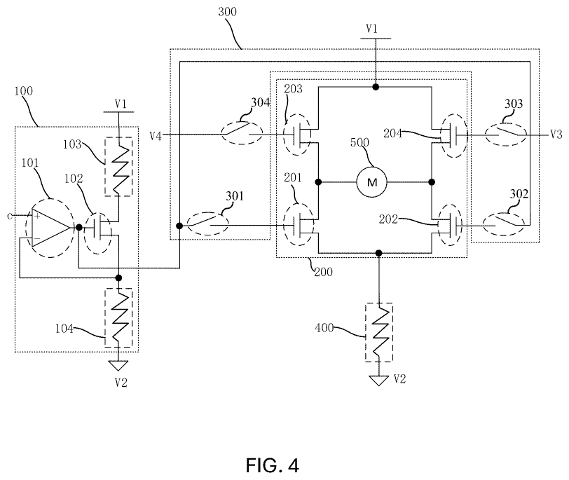

To provide this functionality, as shown in FIG. 4, switching circuit 300 includes: Third Switch 303: Coupled between the turn-on voltage V3 of fifth switching transistor 204 and its control terminal. Configured to maintain a conducting state in response to a first control signal being valid. Fourth Switch 304: Coupled between the turn-on voltage V4 of fourth switching transistor 203 and its control terminal. Configured to maintain a conducting state in response to a second control signal being valid.

It should be noted that the circuit 300 shown in FIGS. 3 and 4 have been simplified to clearly demonstrate its bi-directional functionality. For brevity, the inputs for the first and second control signals—typically provided by an external logic circuit, microcontroller, or other user control mechanism (including PWM)—have been omitted. However, these inputs are input from a microcontroller or a control circuit or any other control input, similar to control signals S1-S4 shown in FIG. 1, and should be apparent to those skilled in the art.

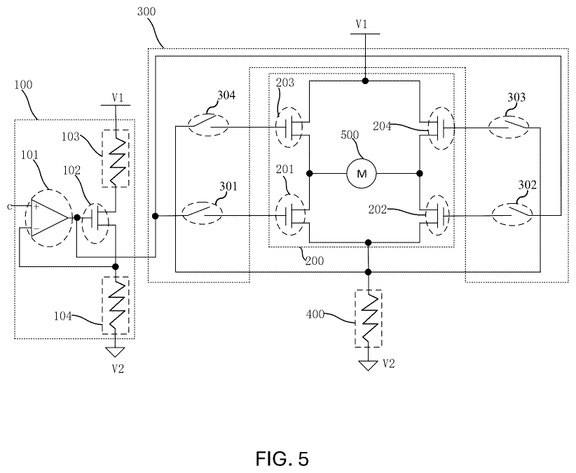

In some embodiments, to simplify the drive circuit, the types of the fourth and fifth switching transistors can be chosen so their turn-on voltages are existing voltages like V1 or V2 For example, setting them as transistors that turn on at ground voltage V2, as shown in FIG. 5.

The driving of motor 500 requires that while one pair of diagonally arranged transistors conducts, the other pair turns off. Therefore, switching circuit 300 must also control the turn-off states.

In some embodiments, since a switching transistor can be considered off when its control terminal is not connected, the corresponding transistors can be turned off by opening the switches (301-304). Alternatively, transistors can be turned off by connecting their control terminals to their turn-off voltages.

Based on this, switching circuit 300 can further be configured to:
In response to a third control signal being valid, connect the control terminal of third switching transistor 202 to its turn-off voltage.
In response to a fourth control signal being valid, connect the control terminal of second switching transistor 201 to its turn-off voltage.

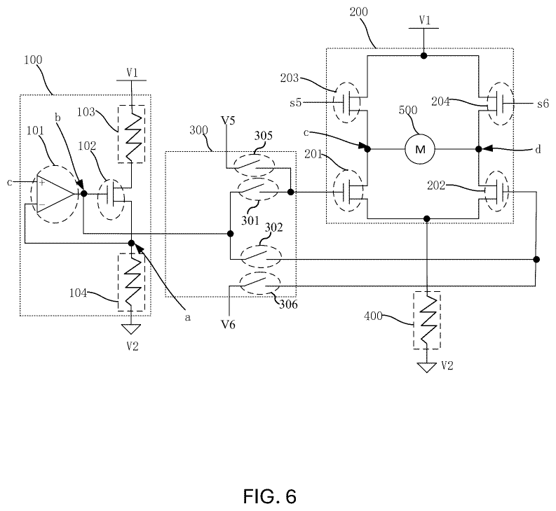

To achieve this, as shown in FIG. 6, switching circuit 300 includes:
Fifth Switch 305: Coupled between the control terminal of second switching transistor 201 and its turn-off voltage V5. Configured to conduct when the third control signal is valid.
Sixth Switch 306: Coupled between the control terminal of third switching transistor 202 and its turn-off voltage V6. Configured to conduct when the fourth control signal is valid.

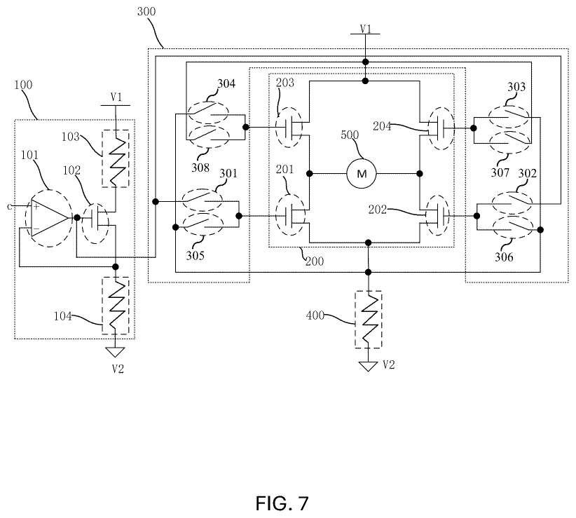

Similarly, to ensure that the diagonally arranged pairs of transistors turn off simultaneously, switching circuit 300 can include: seventh Switch 307: Coupled between the control terminal of fifth switching transistor 204 and its turn-off voltage. Configured to conduct when the third control signal is valid. Eighth Switch 308: Coupled between the control terminal of fourth switching transistor 203 and its turn-off voltage. Configured to conduct when the fourth control signal is valid. This is illustrated in FIG. 7.

It should be noted that in FIG. 7, to facilitate a better understanding by those skilled in the art of the connections between the various switching transistors in H-bridge circuit 200 and the various switches in switching circuit 300, the drive circuit is illustrated by way of example where:
The turn-off voltage of second switching transistor 201 is the ground voltage V2.
The turn-off voltage of third switching transistor 202 is the ground voltage V2.
The turn-on voltage and turn-off voltage of fourth switching transistor 203 are, respectively, the ground voltage V2 and the power supply voltage V1.
The turn-on voltage and turn-off voltage of fifth switching transistor 204 are, respectively, the power supply voltage V1 and the ground voltage V2.

In other embodiments, independent turn-off voltages may be provided for each switching transistor in the H-bridge circuit, and independent turn-on voltages may be provided for fourth switching transistor 203 and fifth switching transistor 204. These variations will not be elaborated upon here.

Similarly, the circuit 300 in FIGS. 5-7 has been simplified to highlight its bi-directional

functionality. The inputs for the third and fourth control signals, similar to the first and second control signals mentioned earlier, are typically provided by an external logic circuit, microcontroller, or other user control mechanism (e.g., PWM) and have been omitted for clarity. These inputs, like control signals s5 and s6, can be implemented as needed for a specific application and will be apparent to those skilled in the art.

In some embodiments, to improve the control accuracy of the driving current supplied to the motor, the resistance value of matching resistor 400 satisfies: k×R2=R3, where R2 is the resistance of the second resistor 104, R3 is the resistance of matching resistor 400, and k is the ratio of the channel width-to-length ratio of the first switching transistor 102 to that of second switching transistor 201.

The second and third switching transistors have the same channel width-to-length ratio. This proportional relationship allows the current in the constant current source circuit to be mirrored to the H-bridge circuit by a factor of k, enabling better control of the driving current supplied to motor 500.

It should be noted that, in some embodiments, second switching transistor 201 and third switching transistor 202 may have different channel width-to-length ratios. In this case, matching resistor 400 may have two resistance values: When second switching transistor 201 is conducting, the resistance value of matching resistor 400 satisfies k1×R2=R3′; When third switching transistor 202 is conducting, the resistance value of matching resistor 400 satisfies k2×R2=R3″. Where:
k1 is the ratio of the channel width-to-length ratio of the first switching transistor 102 to that of second switching transistor 201.
k2 is the ratio of the channel width-to-length ratio of the first switching transistor 102 to that of third switching transistor 202.
R2 is the resistance value of the second resistor 104.
R3′ and R3″ are the two resistance values of matching resistor 400.

In some embodiments, since first resistor 103 is typically an external component in the operational amplifier constant current source circuit 100, it can be configured as a variable resistor. By adjusting the resistance value of first resistor 103, the resistance ratio of motor 500 under direct current (DC) conditions can be mirrored into the operational amplifier constant current source circuit 100, achieving a more accurate mirroring between the operational amplifier constant current source circuit 100 and H-bridge circuit 200.

That is, by providing an adjustable first resistor 103, the drive circuit can supply driving currents to different motors. By adjusting first resistor 103, the mirroring accuracy between the operational amplifier constant current source circuit 100 and H-bridge circuit 200 can be enhanced. This allows the current from the operational amplifier constant current source circuit 100 to be precisely mirrored into H-bridge circuit 200, providing motor 500 with a precisely controlled driving current.

To enable those skilled in the art to better understand the relationship between the control signals and the operating state of motor 500 in the drive circuit provided by the above embodiments, the experimental results of the circuit shown in FIG. 7 are presented below.

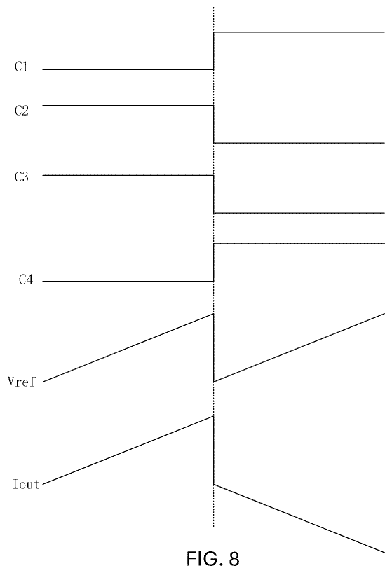

As shown in FIG. 8, when:
The first control signal C1 transitions from invalid to valid,
The second control signal C2 transitions from valid to invalid,
The third control signal C3 transitions from valid to invalid,
The fourth control signal C4 transitions from invalid to valid,
   the third and fourth switching transistors (e.g., 202 and 203) are first turned on while the second and fifth (e.g., 201 and 204) are turned off, then vice versa. Assuming the voltage signal Vref is as shown, the driving current Iₒᵤₜ supplied to motor 500 will first drive it forward, then reverse.

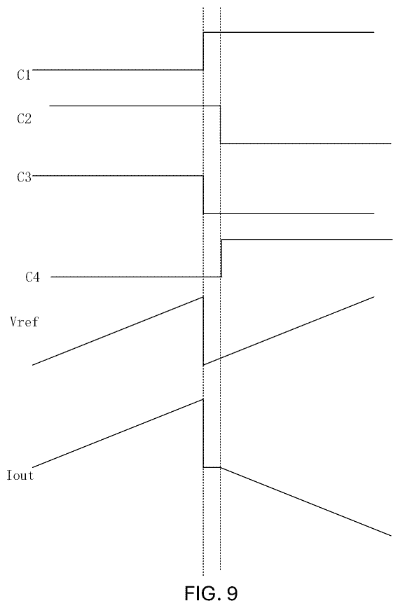

Specifically, the drive circuit also provides a zero-current output mode. As shown in FIG. 9, between the two dashed lines, both the first control signal (C1) and the second control signal (C2) are concurrently valid, and the third control signal (C3) and the fourth control signal (C4) are concurrently invalid. All switching transistors in the H-bridge circuit (e.g., 200 of FIG. 5) conduct, the voltages at both ends of the motor (e.g., 500 of FIG. 3) are the same, and the motor (e.g., 500 of FIG. 5) is in a floating state with zero driving current. This mode allows the motor (500 of FIG. 5) to transition more easily to the operating state without damage, benefiting its maintenance. In other words, when motor 500 is not needed in motor 500 workspace, setting the drive circuit to the zero-output mode is more conducive to restarting motor 500 for operation and entering the working state. It also benefits the maintenance of motor 500.

It should be noted that in the zero-current output mode, matching resistor 400 prevents a short circuit caused by directly connecting the supply voltage V1 to ground V2, providing circuit protection.

Another aspect of the embodiments further provides a chip comprising the drive circuit as described above. This embodiment corresponds to the chip implementation of the circuit embodiments and can be implemented in conjunction with them. The technical details mentioned in the circuit embodiments are still valid here and are not repeated to reduce redundancy. Accordingly, the technical details mentioned here can also be applied to the circuit embodiments.

A further aspect of the embodiments further provides an electronic device comprising the above-mentioned chip.

By implementing the above-described drive circuit, chip, and electronic device, the stability and precision of driving currents supplied to motors in high-frequency environments are significantly improved, addressing the limitations of prior art drive circuits.

Another embodiment of the invention disclosed in this application relates to a computer-readable storage medium storing a computer program. When executed by a processor, the computer program implements the aforementioned method embodiments.

That is to say, those skilled in the art can understand that all or part of the steps in the above-described method embodiments can be accomplished by a program instructing related hardware. This program is stored in a storage medium and includes several instructions for causing a device (which can be a microcontroller, chip, etc.) or processor to execute all or part of the steps of the methods described in the various embodiments of this application. The aforementioned storage medium includes various media that can store program code, such as USB drives, portable hard drives, read-only memory (ROM), random access memory (RAM), magnetic disks, or optical discs.

One of ordinary skill in the art will understand that the above embodiments are specific implementations of the invention disclosed in this application. In practical application, various changes can be made in form and detail without departing from the spirit and scope of the invention.

What is claimed is:

1. A drive circuit, comprising:
a matching resistor, wherein one end of the matching resistor is coupled to a ground voltage;
an operational amplifier constant current source circuit, wherein the operational amplifier constant current source circuit comprises an operational amplifier, a first switching transistor, a first resistor, and a second resistor, the first resistor coupled between a supply voltage and an input terminal of the first switching transistor, the second resistor coupled between a first node and the ground voltage, the operational amplifier having an inverting input terminal coupled to an output terminal of the first switching transistor at the first node, an output terminal coupled to a control terminal of the first switching transistor at a second node, and a non-inverting input terminal configured to receive an input voltage signal;
an H-bridge circuit, comprising a second switching transistor, a third switching transistor, a fourth switching transistor, and a fifth switching transistor, wherein the H-bridge circuit, coupled between the supply voltage and another end of the matching resistor; and
a switching circuit, wherein the switching circuit is coupled to the second node, a control terminal of the second switching transistor, and a control terminal of the third switching transistor, wherein the switching circuit is configured to connect the second node to the control terminal of the second switching transistor in response to a first control signal.

2. The drive circuit of claim 1, wherein the switching circuit comprises:
a first switch coupled between the second node and the control terminal of the second switching transistor, configured to remain in a conducting state based on first control signal; and
a second switch coupled between the second node and the control terminal of the third switching transistor, configured to remain in a conducting state based on second control signal.

3. The drive circuit of claim 1, wherein the switching circuit is further configured to:
based on the first control signal, concurrently connect a control terminal of the fifth switching transistor to a conduction voltage terminal of the fifth switching transistor and the second node to the control terminal of the second switching transistor; and
concurrently connect a control terminal of the fourth switching transistor to a conduction voltage terminal of the fourth switching transistor according to the second control signal and the second node to the control terminal of the third switching transistor.

4. The drive circuit of claim 3, wherein the switching circuit further comprises:
a third switch coupled between the conduction voltage terminal of the fifth switching transistor and the control terminal of the fifth switching transistor, configured to remain in a conducting state in response to the first control signal; and
a fourth switch coupled between the conduction voltage terminal of the fourth switching transistor and the control terminal of the fourth switching transistor, configured to remain in a conducting state in response to the second control signal.

5. The drive circuit of claim 1, wherein the switching circuit is further configured to:
connect the control terminal of the second switching transistor to a cutoff voltage terminal of the second switching transistor in response to a third control signal; and
connect the control terminal of the third switching transistor to a cutoff voltage terminal of the third switching transistor in response to a fourth control signal.

6. The drive circuit of claim 5, wherein the switching circuit further comprises:
a fifth switch coupled between the control terminal of the second switching transistor and a cutoff voltage terminal of the second switching transistor, configured to remain in a conducting state according to the third control signal; and
a sixth switch coupled between the control terminal of the third switching transistor and the cutoff voltage terminal of the third switching transistor, configured to remain in a conducting state in response to the fourth control signal.

7. The drive circuit of claim 5, wherein the switching circuit is further configured to:
connect the control terminal of the fifth switching transistor to a cutoff voltage terminal of the fifth switching transistor in response to the valid third control signal, simultaneously while connecting the control terminal of the second switching transistor to its cutoff voltage terminal; and
connect the control terminal of the fourth switching transistor to a cutoff voltage terminal of the fourth switching transistor in response to the valid fourth control signal, simultaneously while connecting the control terminal of the third switching transistor to its cutoff voltage terminal.

8. The drive circuit of claim 7, wherein the switching circuit further comprises:
a seventh switch coupled between the control terminal of the fifth switching transistor and its cutoff voltage terminal, configured to remain in a conducting state in response to the valid third control signal; and
an eighth switch coupled between the control terminal of the fourth switching transistor and its cutoff voltage terminal, configured to remain in a conducting state in response to the valid fourth control signal.

9. The drive circuit of claim 1, wherein:
the cutoff voltage terminal of the second switching transistor and the third switching transistor is the ground voltage;
a conduction voltage terminal and the cutoff voltage terminal of the fourth switching transistor are connected to the ground voltage and the supply voltage, respectively;
and the conduction voltage terminal and the cutoff voltage terminal of the fifth switching transistor are the supply voltage and the ground voltage, respectively.

10. The drive circuit of claim 1, wherein the matching resistor has a resistance value R3 that satisfies equation k*R2=R3, where the second resistor has a resistance value R2, and k is channel width-to-length ratio of the first switching transistor divided by channel width-to-length ratio of the second switching transistor.

11. The drive circuit of claim 1, wherein the H-bridge circuit is configured to provide a driving current to a motor under a condition where both the second switching transistor and fifth switching transistor are conducting and the third switching transistor and fourth switching transistor are non-conducting, or under a condition where the second and fifth switching transistors are non-conducting and the third and fourth switching transistors are conducting, wherein the second and fifth switching transistors are diagonally arranged, and the third and fourth switching transistors are diagonally arranged.

12. The drive circuit of claim 1, wherein the switching circuit is further configured to connect the second node to the control terminal of the third switching transistor in response to a second control signal and to control the conduction of the second or third switching transistors based on voltage at the second node.

13. A chip comprising the drive circuit of any one of claims 1 to 10.

14. An electronic device comprising the chip of claim 11.
